(19) United States
(12) Patent Application Publication
(10) Pub. No.: US 2007/0158567 A1
(43) Pub. Date: Jul. 12, 2007

(54) Apparatus and adjusting method for a scanning transmission electron microscope

(76) Inventors: Taisuke Nakamura, Kokubunji (JP); Kuniyasu Nakamura, Musashino (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/644,877

(22) Filed: Dec. 26, 2006

(30) Foreign Application Priority Data
Dec. 26, 2005 (JP) 2005-371291

(51) Int. Cl. G21K 7/00

(52) U.S. Cl. 250/311

(57) ABSTRACT

A scanning transmission electron microscope is provided including an electron beam source (1), convergent lenses (3), scan coils (10), a dark field image detector (16), a bright field image detector (17), an A/D converter (21), and an information processing device (24). In the scanning transmission electron microscope, a spherical aberration corrector (7) and deflection coils (9a, 9b) are disposed before a pre-magnetic field of objective lens (11). Fourier transform images are produced from scanning transmission images obtained by the dark field image detector (16) or the bright field image detector (17) to evaluate deviation in an aberration correction state due to an image shift caused by the deflection coils (9a, 9b) at a deflection ratio, so a suitable deflection ratio is fed back. As a result, an electron optics of the scanning transmission electron microscope including the corrector can be easily adjusted.

### CLAIM OF PRIORITY

The present application claims priority from Japanese application JP 2005-371291 filed on Dec. 26, 2005, the content of which is hereby incorporated by reference into this application.

### BACKGROUND OF THE INVENTION

The present invention relates to a scanning transmission electron microscope including a corrector, and more particularly, to a technique of adjusting a deflector of the scanning transmission electron microscope including the corrector.

A scanning transmission electron microscope having an image shift function is known in the conventional art. The image shift function is realized using upper and lower deflection coils provided in an electron optics which scans a specimen with an electron beam. Specifically, the electron beam deflected by the upper deflection coil is deflected to a deflection fulcrum in a reverse direction by the lower deflection coil. Therefore, an electron beam irradiation position on the specimen is adjusted without moving a goniometer stage that causes a drift, thereby obtaining a scanning transmission image. In a conventional method which adjusts a deflection ratio between the upper and lower deflection coils for the image shift function, an image obtained before image shift is simply compared with an image obtained after image shift and the electron optics is adjusted to prevent the occurrence of deflection aberration or aberration caused by optical axis deviation.

As a conventional deflection coil adjusting method, a method described in “F. Zemlin, K. Weiss, P. Schiske, W. Kunath, and K.-H. Herrmann, “Coma-free alignment of high-resolution electron microscopes with the aid of optical diffractograms”, Ultramicroscopy 3 (1978) 49-60, North-Holland Publishing Company, p. 49 “(hereinafter, referred to as Non-Patent Document 1) is known, being a method which performs coma-free adjustment on an objective lens. According to this method, a set of Fourier transform images produced from transmission images obtained based on electron beams tilted in various directions by the upper and lower deflection coils are used to adjust the deflector such that the electron beams are incident on the objective lens under suitable tilt conditions. The method is employed for optical axis adjustment for using a transmission electron microscope under a coma-free condition.

In recent years, a multipole lens type spherical aberration corrector has entered the practical phase. When the corrector is used for the scanning transmission electron microscope, a resolution of 0.1 nm or less can be realized even in cases of a scanning transmission electron microscope whose acceleration voltage is 200 kV or less. However, when electron beam aberration is to be corrected using the multipole lens type spherical aberration corrector, it is necessary to form a specific electron beam trajectory in the inner portion of the corrector. Therefore, in the case where the multipole lens type spherical aberration corrector is mounted on the scanning transmission electron microscope, when the optical axis adjustment between the corrector and an electron microscope main body is not performed with sufficient precision or the optical axis deviation occurs, the aberration increases because of the mounted corrector.

Therefore, in the scanning transmission electron microscope on which the multipole lens type spherical aberration corrector is mounted, when the electron optics is to be adjusted using the conventional method which adjusts the deflection ratio between the upper and lower deflection coils for the image shift function, very high optical axis adjustment precision is required. In addition, it is also necessary to adjust the deflection ratio according to excitation setting of the corrector. Thus, a condition sufficient to perform high-resolution observation cannot be satisfied.

### SUMMARY OF THE INVENTION

The present invention has been made in view of the above-mentioned circumstances. An object of the present invention is to enable easy adjustment of a deflector of a scanning transmission electron microscope including a corrector.

In order to solve the above-mentioned problem, the present invention provides a scanning transmission electron microscope including the corrector, an incident electron beam is deflected by two or more stages of deflection coils, and Fourier transform images are produced based on scanning transmission images obtained before and after image shift. The Fourier transform images are compared with each other to make it possible to determine degree of adjustment of the deflection ratio between the deflection coils.

According to the present invention, the degree of adjustment of the deflection ratio between the deflection coils can be determined based on a result obtained by comparison between the Fourier transform images produced from the scanning transmission images obtained before and after the image shift. Therefore, even in the case of the scanning transmission electron microscope on which the corrector is mounted, the image shift can be performed with an aberration correction state being maintained.

### BRIEF DESCRIPTION OF THE DRAWINGS

In the accompanying drawings:

FIG. 1 is a schematic configuration diagram showing a scanning transmission electron microscope according to a first embodiment of the present invention;

FIG. 2 is a schematic diagram showing a state of an electron beam to explain adjustment of a deflection ratio between deflection coils;

FIG. 3A shows regions on a specimen in which scanning transmission images are obtained to adjust the deflection ratio between the deflection coils, and FIGS. 3B and 3C each show Fourier transform images which are produced from the obtained scanning transmission images and arranged in positions corresponding to the amounts of beam shift of electron beams and orientation angles thereof;

FIGS. 4A and 4B are explanatory diagrams showing a method which adjusts the deflection ratio between the deflection coils using an initially tilted electron beam, and FIG. 4C shows a set of Fourier transform images obtained in the case where the deflection ratio between the deflection coils is adjusted to obtain a suitable deflection ratio using the initially tilted electron beam;

FIGS. 5A and 5B are explanatory diagrams showing the method which adjusts the deflection ratio between the deflection coils using the initially tilted electron beam, and FIG. 5C shows the set of Fourier transform images obtained in the case where the deflection ratio between the deflection coils is adjusted to obtain an unsuitable deflection ratio using the initially tilted electron beam;

FIG. 6 is an explanatory flowchart showing an operation flow in cases where the deflection ratio between the deflection coils is adjusted in the scanning transmission electron microscope according to the first embodiment of the present invention;

FIG. 7 shows an example of an interactive screen used during the operation flow shown in FIG. 6;

FIG. 8 shows an example of the interactive screen, in which degree of agreement between Fourier transform images obtained after and before beam shift is used for result display;

FIG. 9 is an explanatory diagram showing positions of deflection fulcrums related to the deflection coils;

FIG. 10 is an explanatory flowchart showing an operation flow in cases where the deflection ratio between the deflection coils is adjusted in a scanning transmission electron microscope according to a second embodiment of the present invention;

FIG. 11 shows an example of an interactive screen used during the operation flow shown in FIG. 10;

FIG. 12A is a schematic diagram showing a state of electron beams passing through a plurality of deflection fulcrums and FIG. 12B shows Fourier transform images produced from scanning transmission images associated with deflection ratios realizing the respective deflection fulcrums shown in FIG. 12A;

FIG. 13 shows a set of a Fourier transform image obtained in cases where the beam shift is performed in a direction indicated by an orientation angle φ and a Fourier transform image obtained in cases where the beam shift is performed in a direction indicated by the orientation angle φ+180°, for each deflection ratio employed for the beam shift; and

FIG. 14 is an explanatory flowchart showing an operation flow in cases where the deflection ratio between the deflection coils is adjusted in a scanning transmission electron microscope according to a third embodiment of the present invention.

### DESCRIPTION OF THE PREFERRED EMBODIMENTS

### First Embodiment

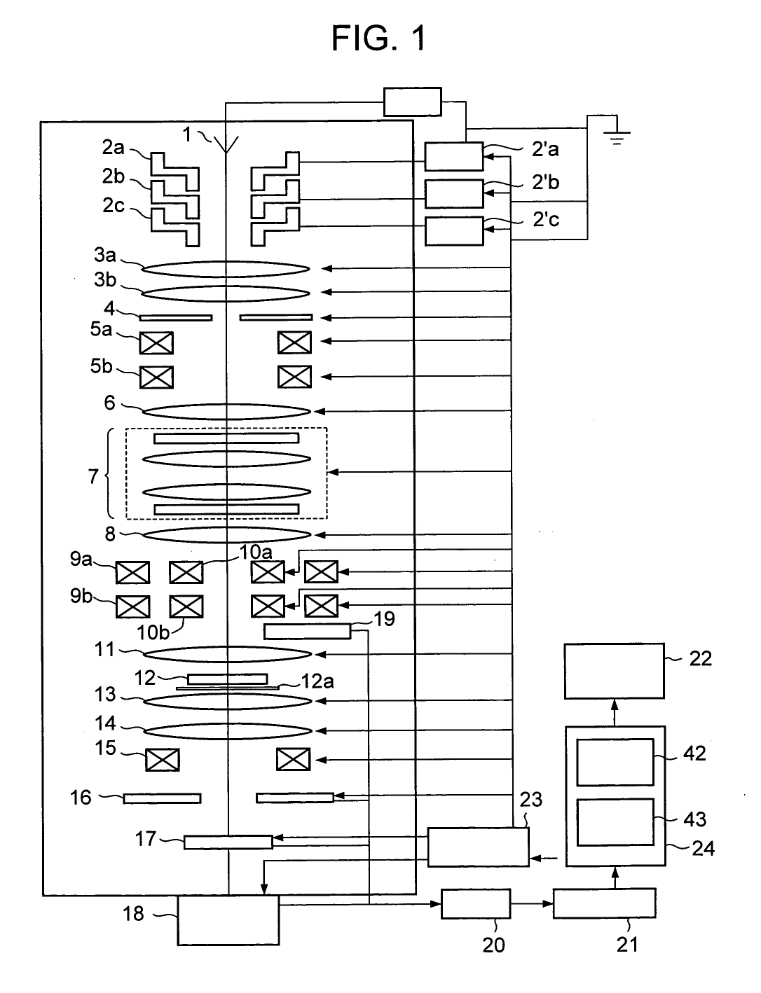

FIG. 1 is a schematic diagram showing a scanning transmission electron microscope according to a first embodiment of the present invention.

As shown in FIG. 1, the scanning transmission electron microscope according to this embodiment includes an electron beam source 1 which emits an electron, electrostatic lenses 2a to 2c, voltage control devices 2′a to 2′c which control voltages applied to the electrostatic lenses 2a to 2c, convergent lenses 3a and 3b, a convergent diaphragm 4 provided under the convergent lens 3b, an upper deflection coil 5a for corrector axis adjustment, a lower deflection coil 5b for corrector axis adjustment, an adjustment lens 6, a spherical aberration corrector 7, a transfer lens 8, an upper deflection coil 9a, a lower deflection coil 9b, scan coils 10a and 10b, a pre-magnetic field of objective lens 11, a specimen stage 12a on which a specimen 12 is placed, a post-magnetic field of objective lens 13, a projection lens 14, a detection system alignment coil 15 provided under the projection lens 14, a dark field image detector 16, a bright field image detector 17, a camera 18, a secondary electron detector 19, a preamplifier 20, an A/D converter 21, a user interface 22, a D/A converter 23, and an information processing device 24. The information processing device 24 includes a processor 42 and a memory unit 43.

In the scanning transmission electron microscope having the above-mentioned configuration, an electron beam emitted from the electron beam source 1 is accelerated to a predetermined acceleration voltage by the electrostatic lenses 2a to 2c with applied voltages controlled by the voltage control devices 2′a to 2′c.

Next, a size of the electron beam accelerated to the predetermined acceleration voltage is reduced by the convergent lenses 3a and 3b. An arbitrary reduction ratio can be realized by a current excitation combination of the convergent lenses 3a and 3b. An aperture angle of the electron beam is adjusted by the convergent diaphragm 4 located under the convergent lens 3b, so a balance between spherical aberration and diffraction aberration which affect the electron beam can be adjusted. The convergent diaphragm 4 includes various holes having different diameters, and is configured so as to be able to be manually or automatically removed from an optical axis.

Next, an incident angle of the electron beam passing through the convergent diaphragm 4 on the spherical aberration corrector 7 is finely adjusted by the upper deflection coil 5a for corrector axis adjustment, the lower deflection coil 5b for corrector axis adjustment, and the adjustment lens 6. Therefore, the optical axis of an electron optics of the scanning transmission electron microscope can be aligned with the optical axis of the spherical aberration corrector 7. The electron beam passes through the spherical aberration corrector 7, thereby correcting aberration such as spherical aberration or astigmatism. The spherical aberration corrector 7 is composed of a multistage multipole lens, a rotationally symmetric lens, and a deflection coil. A voltage or an excitation current applied to each pole of the multipole lens and the rotationally symmetric lens is controlled to adjust the amount of correction of aberration.

After passing through the spherical aberration corrector 7, the electron beam passes through the transfer lens 8. The specimen 12 placed on the specimen stage 12a is two-dimensionally scanned with the electron beam by the scan coils 10a and 10b through the pre-magnetic field of objective lens 11. At this time, when the electron beam incident on the specimen 12 can be tilted by a combination of the upper deflection coil 5a for corrector axis adjustment and the lower deflection coil 5b for corrector axis adjustment or a combination of the upper deflection coil 9a and the lower deflection coil 9b which are located under the transfer lens 8, an incident angle of the electron beam on the specimen 12 can be controlled. When the electron beam is deflected by the upper deflection coil 9a and the lower deflection coil 9b, the amount of beam shift of the electron beam on the surface of the specimen 12 can be controlled. Note that a configuration including at least two sets of coils which generate dipole field components is used for each of the deflection coils 5a, 5b, 9a, and 9b. Hereinafter, the tilt of the electron beam is referred to as a beam tilt and the deflection of the electron beam is referred to as a beam shift.

After passing through the specimen 12, the electron beam passes through the post magnetic field of objective lens 13 and the projection lens 14. The electron beam is adjusted by the detection system alignment coil 15 provided under the projection lens 14 such that an optical axis of the electron beam is aligned with optical axes of the dark field image detector 16, the bright field image detector 17, and the camera 18. Even when an electron beam diffraction image or a scanning transmission image is significantly deviated from the optical axes of the dark field image detector 16, the bright field image detector 17, and the camera 18 by the beam tilt or the beam shift, the axis alignment is performed using the detection system alignment coil 15.

The dark field image detector 16 or the bright field image detector 17 modulates, to an image intensity, the brightness of a signal obtained in synchronization with scanning the surface of the specimen 12 with the electron beam, thereby obtaining a scanning transmission image. The image intensity of the scanning transmission image is amplified by the preamplifier 20 and then A/D-converted by the A/D converter 21. The information processing device 24 causes the memory unit 43 to store the digitized scanning transmission image as a digital image file.

The bright field image detector 17 is disposed on the optical axis. Therefore, a movable mechanism capable of removing the bright field image detector 17 from the optical axis, in cases where the camera 18 is used, is provided. A device having high sensitivity, a high S/N ratio, and high linearity, such as a CCD or a Harpicon camera is used as the camera 18. The camera 18 performs quantitative recording of a diffraction image intensity of the electron beam passing through the specimen 12. An image pick up signal from the camera 18 is amplified by the preamplifier 20 and then A/D-converted by the A/D converter 21. The information processing device 24 causes the memory unit 43 to store the digitized image pickup signal as a digital image file. A camera length on a surface of the camera 18 can be arbitrarily adjusted by the projection lens 14. Thus, an electron beam diffraction image on an arbitrary imaging surface can be observed.

The processor 42 of the information processing device 24 controls the lenses, the coils, and the detectors which are used in the above-mentioned series of operation, through the D/A converter 23. The processor 42 receives a condition necessary for operation from an operator through the user interface 22 and presents information to the operator.

The secondary electron detector 19 is provided above the pre-magnetic field of objective lens 11. Therefore, according to the scanning transmission electron microscope in this embodiment, a secondary electron image can be obtained in addition to the above-mentioned scanning transmission image. The secondary electron image from the secondary electron detector 19 is amplified by the preamplifier 20 and then A/D-converted by the A/D converter 21. The information processing device 24 causes the memory unit 43 to store the digitized secondary electron image as a digital image file.

Next, a method which adjusts the deflection ratio between the deflection coils 9a and 9b in the scanning transmission electron microscope including the spherical aberration corrector 7, having the above-mentioned configuration, will be described.

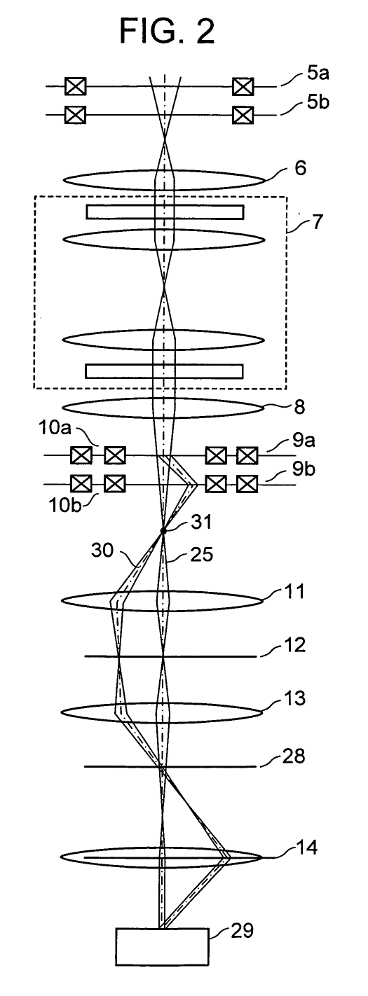

The deflection coils 9a and 9b are adjusted after the optical axis adjustment of the spherical aberration corrector 7 and excitation setting are completed. FIG. 2 is an explanatory diagram showing a configuration for adjusting the deflection ratio between the deflection coils in the scanning transmission electron microscope shown in FIG. 1.

As described above, the beam shift is made by the upper deflection coil 9a and the lower deflection coil 9b. An electron beam (deflected electron beam) 30 deflected by the upper deflection coil 9a and the lower deflection coil 9b crosses the optical axis at a deflection fulcrum 31. The defected electron beam 30 is converged by the pre-magnetic field of objective lens 11 and then incident on the specimen 12. At this time, the deflected electron beam 30 is adjusted such that it is substantially perpendicularly incident on the specimen 12. Therefore, after passing through the specimen 12, the deflected electron beam 30 reaches the same position as that of an electron beam 25 traveling along the optical axis within a back focal plane 28 through the post-magnetic field of objective lens 13. After that, an image of the deflected electron beam 30 passing through the back focal plane 28 is formed on a detector 29 (dark field image detector 16, bright field image detector 17, camera 18, or the like) by the projection lens 14.

Next, an image acquiring method which adjusts the deflection ratio between the deflection coils 9a and 9b in the scanning transmission electron microscope including the spherical aberration corrector 7, having the above-mentioned configuration, will be described.

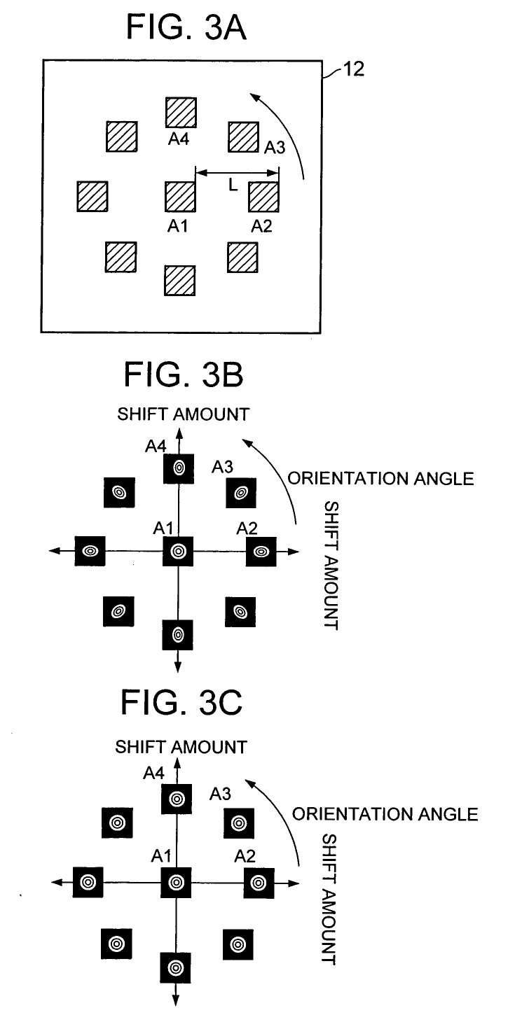

FIG. 3A shows image acquisition regions on the surface of the specimen 12 in cases where the specimen 12 is viewed from an optical axis direction. Examples of the standard specimen 12 used to adjust the deflection ratio include: an amorphous specimen; gold particles each having a suitable particle diameter (approximately 50 nm or less in diameter) which are randomly arranged on a carbon film; a latex ball; a platinum particle; an aluminum particle; an Si particle; and a pattern including repeated figures such as circles, rectangles, or triangles, which are drawn on a substrate.

The processor 42 of the information processing device 24 operates a main body of the scanning transmission electron microscope through the D/A converter 23. First, the processor 42 causes any one of the dark field image detector 16, the bright field image detector 17, and the camera 18 to detect a scanning transmission image in an irradiation region A1 located on the surface of the specimen 12 without performing the beam shift of the electron beam, that is, with a state where a traveling direction of the electron beam is aligned with the optical axis. The detected scanning transmission image is stored in the memory unit 43 through the preamplifier 20 and the A/D converter 21.

Next, the processor 42 controls the upper deflection coil 9a and the lower deflection coil 9b through the D/A converter 23 to perform the beam shift of the electron beam. Therefore, a scanning transmission image in an irradiation region A2 located on the surface of the specimen 12 is detected by any one of the dark field image detector 16, the bright field image detector 17, and the camera 18. The detected scanning transmission image is stored in the memory unit 43 through the preamplifier 20 and the A/D converter 21. A distance L between the irradiation region A1 and the irradiation region A2 corresponds to the amount of beam shift of the electron beam.

Next, the processor 42 controls the upper deflection coil 9a and the lower deflection coil 9b through the D/A converter 23 to sequentially change an orientation angle of the electron beam deflected by the beam shift. Therefore, scanning transmission images in a plurality of irradiation regions including irradiation regions A3 and A4 which are located on the surface of the specimen 12 are sequentially detected by any one of the dark field image detector 16, the bright field image detector 17, and the camera 18. The detected scanning transmission images are stored in the memory unit 43 through the preamplifier 20 and the A/D converter 21. The scanning transmission image acquisition order is not limited to the above-mentioned order. The plurality of irradiation regions including the irradiation regions A3 and A4 are set in 2n (n is natural number) rotation symmetrical positions (for example, positions including two rotation symmetrical positions, four rotation symmetrical positions, and six rotation symmetrical positions) relative to the irradiation region A1 as the center.

After that, in order to easily understand a deviation in correction state of the corrector which is caused by the beam shift, the processor 42 produces Fourier transform images from the respective scanning transmission images stored in the memory unit 43 and causes the memory unit 43 to store the produced Fourier transform images. The processor 42 produces display data including the Fourier transform images stored in the memory unit 43 and causes the user interface 22 to display the produced display data.

The Fourier transform image produced from the scanning transmission image detected by photographing the standard specimen 12 includes a ring pattern reflecting a transfer function, which is determined by the aberration of the scanning transmission electron microscope. It is known that a shape of the ring pattern and an inter-ring distance sensitively reflect the influence of aberration. Therefore, the processor 42 sets the Fourier transform image associated with each of the irradiation regions A1, A2, . . . , which is stored in the memory unit 43, in coordinates determined based on the amount of shift and the orientation angle with respect to the beam shift in cases where a corresponding scanning transmission image is obtained. Therefore, the display data as shown in FIG. 3B or 3C is produced and displayed on the user interface 22.

When the deflection ratio between the upper deflection coil 9a and the lower deflection coil 9b is not suitable, a deviation between the optical axis of the main body of the scanning transmission electron microscope and the optical axis of the spherical aberration corrector 7 is caused by the beam shift. Therefore, a correction state of the spherical aberration is unbalanced. Thus, for example, as shown in FIG. 3B, each of the Fourier transform images obtained after the beam shift becomes an elliptical ring pattern obtained by distorting a pattern of the Fourier transform image which is located at the image center and obtained before the beam shift. This shows that the correction state of the spherical aberration corrector 7 is unbalanced by the beam shift.

On the other hand, when the deflection ratio between the upper deflection coil 9a and the lower deflection coil 9b is suitable, the correction state of the spherical aberration corrector 7 is maintained. Therefore, as shown in FIG. 3C, each of the Fourier transform images obtained after the beam shift becomes a perfectly circular ring pattern identical to the pattern of the Fourier transform image which is located at the image center and obtained before the beam shift.

In the scanning transmission electron microscope according to this embodiment, only the following is necessary. An operator finds a deflection ratio between the upper deflection coil 9a and the lower deflection coil 9b when the Fourier transform images, which are obtained before and after the beam shift and displayed on the user interface 22, have the same ring pattern as shown in FIG. 3C. Next, the operator sets control values for the scanning transmission electron microscope to the information processing device 24 through the user interface 22 in order to operate the upper deflection coil 9a and the lower deflection coil 9b at the deflection ratio.

However, in a state where the aberration is corrected by the spherical aberration corrector 7, the influence of the spherical aberration becomes smaller. Therefore, even when the deflected electron beam 30 includes a beam tilt component, the Fourier transform image used to adjust the deflection coils 9a and 9b is not influenced thereby. In order to prevent this, in this embodiment, the scanning transmission image is obtained using, as the electron beam for the beam shift, an electron beam initially-tilted to the extent that the ring pattern of the Fourier transform image is not distorted.

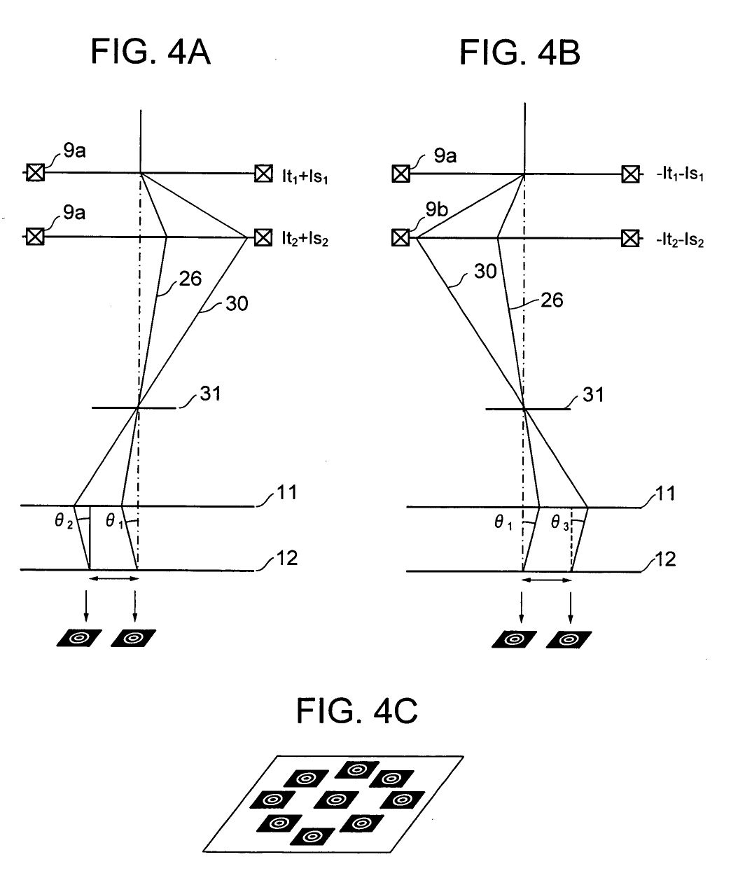

First, as shown in FIG. 4, a scanning transmission image in cases where the beam shift is not performed is obtained using a tilted electron beam 26. The electron beam is initially tilted by applying currents It₁ and It₂ to the upper deflection coil 9a and the lower deflection coil 9b. At this time, an excitation ratio between It₁ and It₂ is set such that a passing position of the tilted electron beam 26 passing through the specimen 12 coincides with a passing position of a non-tilted electron beam passing through the specimen 12. The excitation ratio between the upper deflection coil 9a and the lower deflection coil 9b is adjusted corresponding to the amount of tilt of the extent that a ring pattern is not distorted, so the ring pattern of a Fourier transform image becomes a concentric and perfect circle.

Next, as shown in FIG. 4A, currents Is₁ and Is₂ are further applied to the upper deflection coil 9a and the lower deflection coil 9b to perform the beam shift using (It₁+Is₁) and (It₂+Is₂), thereby obtaining a scanning transmission image. When the deflection ratio at this time is suitable, tilt angles θ₁ and θ₂, caused before and after the beam shift, are equal to each other. A ring pattern of a Fourier transform image has the same concentric and perfect circular pattern.

Subsequently, as shown in FIG. 4B, currents −It₁ and −It₂ are applied to the upper deflection coil 9a and the lower deflection coil 9b to change the orientation angle of the tilted electron beam 26 by 180 degrees. Under such a condition, the adjustment of the corrector 7 is completed, so a pattern caused in a Fourier transform image produced from a scanning transmission image has the same shape as that obtained in cases where the currents It₁ and It₂ are applied to the upper deflection coil 9a and the lower deflection coil 9b of FIG. 4A.

In addition, as shown in FIG. 4B, currents −Is₁ and −Is₂ are further applied to perform the beam shift using −(It₁+Is₁) and −(It₂+Is₂), thereby obtaining a scanning transmission image to produce a Fourier transform image. When the deflection ratio at this time is suitable, the tilt angles θ₁ and θ₂, caused before and after the beam shift, are equal to each other. A ring pattern of the Fourier transform image has the same concentric and perfect circular pattern.

The processor 42 of the information processing device 24 operates the main body of the scanning transmission electron microscope through the D/A converter 23. First, the processor 42 performs the above-mentioned procedure at each of a plurality of orientation angles to cover all orientations and causes the memory unit 43 to store Fourier transform images obtained as results of the procedure. The processor 42 sets each of the Fourier transform images stored in the memory unit 43 in coordinates determined based on the amount of shift and the orientation angle with respect to the beam shift to produce display data. The produced display data is displayed on the user interface 22. Here, when the deflection ratio between the upper deflection coil 9a and the lower deflection coil 9b is suitable, each of Fourier transform images has the concentric and perfect circular pattern as shown in FIG. 4C.

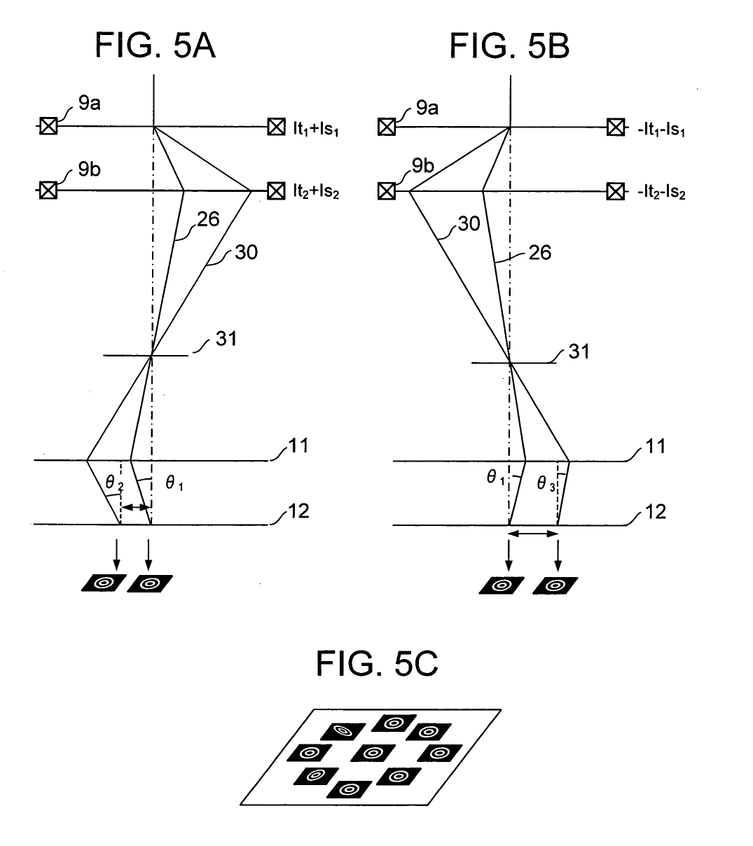

On the other hand, when the deflection ratio between the upper deflection coil 9a and the lower deflection coil 9b is not suitable, a beam tilt component is included in the deflected electron beam 30 by the beam shift. Therefore, as shown in FIG. 5A, when (It₁+Is₁) and (It₂+Is₂) are applied to the upper deflection coil 9a and the lower deflection coil 9b, respectively, to perform the beam shift, a tilt angle relationship is expressed by θ₂>θ₁ because of the presence of the beam tilt component. Thus, a Fourier transform image produced from a scanning transmission image obtained after the beam shift is distorted.

Subsequently, as shown in FIG. 5B, −(It₁+Is₁) and −(It₂+Is₂) are applied to the upper deflection coil 9a and the lower deflection coil 9b, respectively, to change the orientation angle of the tilted electron beam 26 by 180 degrees. Under such a condition, the optical axis significantly deviates due to the beam shift, so a pattern caused in a Fourier transform image produced from a scanning transmission image is also distorted.

The processor 42 of the information processing device 24 operates the main body of the scanning transmission electron microscope through the D/A converter 23. First, the processor 42 performs the above-mentioned procedure at each of a plurality of orientation angles to cover all orientations and causes the memory unit 43 to store Fourier transform images obtained as results of the procedure. Next, the processor 42 sets each of the Fourier transform images stored in the memory unit 43 in coordinates determined based on the amount of shift and the orientation angle with respect to the beam shift to produced is play data. The produced display data is displayed on the user interface 22. The deflection ratio between the upper deflection coil 9a and the lower deflection coil 9b is not suitable, so each of Fourier transform images has an asymmetrical shape as shown in FIG. 5C.

Therefore, when the deflection ratio between the upper deflection coil 9a and the lower deflection coil 9b are adjusted using the initially tilted electron beam 30, the beam tilt component generated by the beam shift is not included therein. In addition to this, only in cases where the correction state of the spherical aberration corrector 7 is normally maintained, each of the Fourier transform images becomes the symmetrical shape, as shown in FIG. 4C. Thus, when control values for the scanning transmission electron microscope are set to the information processing device 24 through the user interface 22 in order to obtain a display screen shown in FIG. 4C, more accurate adjustment can be performed.

Even in this case, it is possible to randomly set the order of obtaining the scanning transmission images. Even in cases where the electron beam is tilted to the extent that the ring pattern of the Fourier transform image, obtained before the beam shift, is distorted, when it can determined that the Fourier transform images obtained before and after the beam shift have the same shape, the adjustment of the deflection ratio between the upper deflection coil 9a and the lower deflection coil 9b can be achieved. The beam tilt may be performed using the upper deflection coil 5a for corrector axis adjustment and the lower deflection coil 5b for corrector axis adjustment.

In the above-mentioned procedure, a pattern including repeated figures such as circles, rectangles, or triangles, which are drawn on a substrate may be used as the standard specimen 12. An image obtained by extracting only a spot shape of the electron beam from the scanning transmission image by a deconvolution method or a Ronchigram may be used instead of the Fourier transform image produced from the scanning transmission image. Note that the Ronchigram is an image reflecting the influence of aberration, which is observed when electron beam scanning is stopped, when the convergent diaphragm 4 is removed from the optical axis or a diaphragm having a sufficiently large hole diameter is set, to increase a convergent angle of the electron beam. The Ronchigram is observed by the camera 18.

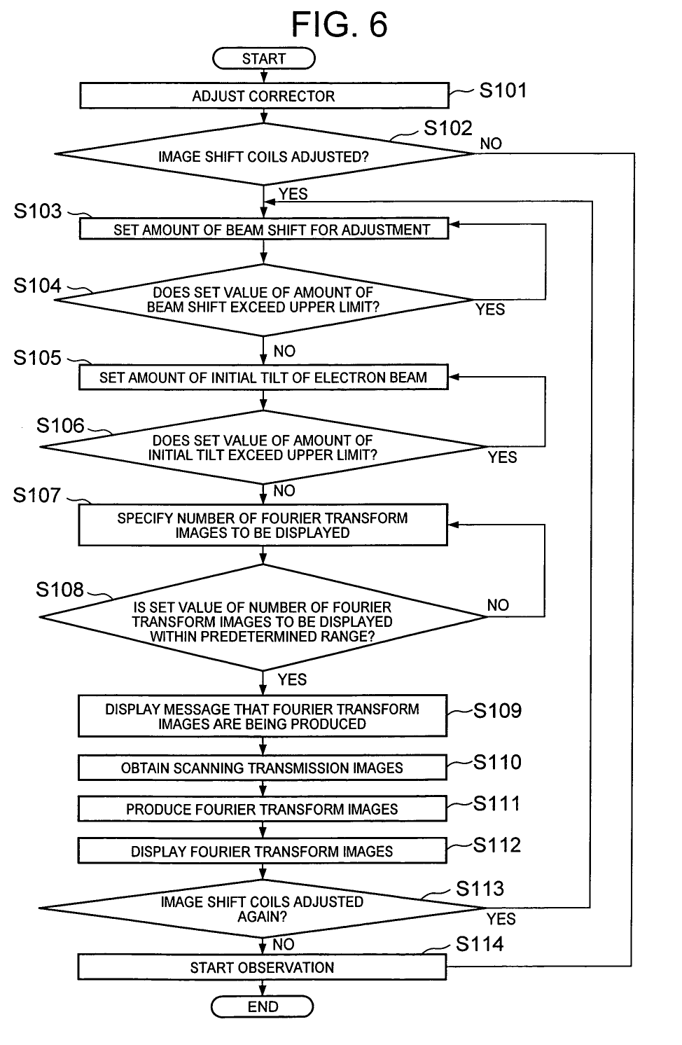

FIG. 6 is an explanatory flowchart showing an operation flow in cases where the deflection ratio between the upper deflection coil 9a and the lower deflection coil 9b is adjusted in the scanning transmission electron microscope according to the first embodiment of the present invention.

As described above, the spherical aberration corrector is firstly adjusted (Step S101). For example, the operator operates an attachment mechanism (not shown) of the spherical aberration corrector 7 to adjust the optical axis of the spherical aberration corrector 7. In addition, the operator sets an excitation value for the spherical aberration corrector 7 to the information processing device 24 through the user interface 22. When the excitation value for the spherical aberration corrector 7 is set by the operator through the user interface 22, for example, the processor 42 of the information processing device 24 causes the user interface 22 to display a message in order to request the operator to determine whether or not it is necessary to adjust the deflection coils 9a and 9b (Step S102).

When an instruction indicating that it is not necessary to adjust the deflection coils 9a and 9b is received from the operator through the user interface 22 (NO in Step S102), the operation immediately moves to an observation mode (Step S114). In the observation mode, the processor 42 operates the main body of the scanning transmission electron microscope based on set values stored in the memory unit 43 in order to observe the scanning transmission images of the specimen 12. A result obtained by observation is stored as a digital image file in the memory unit 43.

On the other hand, when an instruction indicating that it is necessary to adjust the deflection coils 9a and 9b is received from the operator through the user interface 22 (YES in Step S102), the operation shifts to a deflection coil adjustment mode. In the deflection coil adjustment mode, the processor 42 causes the user interface 22 to display an interactive screen. The processor 42 receives the amount of beam shift for adjustment through the interactive screen and causes the memory unit 43 to store the received amount of beam shift (Step S103). In general, when the amount of beam shift is very large, the resultant resolution is reduced by the deflection aberration. Therefore, a maximum value of the amount of beam shift is set in advance. When the received amount of beam shift exceeds the maximum value (YES in Step S104), for example, the processor 42 generates a message indicating that the received amount of beam shift exceeds the maximum value so that the operator inputs the amount of beam shift again (Step S103).

Next, the processor 42 receives, from the operator through the interactive screen, the amount of initial tilt of the electron beam, and causes the memory unit 43 to store the received amount of initial tilt (Step S105). At this time, a maximum tilt angle used to adjust the spherical a berration corrector 7 is displayed as are ference value on the interactive screen. There is a limitation on the tilt angle, so a maximum value of the amount of initial tilt is set in advance. When the received amount of initial tilt exceeds the maximum value (YES in Step S106), for example, the processor 42 generates a message indicating that the received amount of initial tilt exceeds the maximum value in order so that the operator inputs the amount of initial tilt again (Step S105).

Next, the processor 42 receives the number of the Fourier transform images to be obtained from the operator through the interactive screen (Step S107). In each example shown in FIGS. 3A to 3C, the nine Fourier transform images are used. However, the number of Fourier transform images is not limited to nine. For example, when the deflection coils 9a and 9b includes coils which generate two dipole fields orthogonal to each other, it is only necessary to use a Fourier transform image which is obtained before the beam shift and is located in the center of the display screen for displaying Fourier transform images, and four Fourier transform images obtained in the case where the beam shift is performed at respective orientation angles of 0°, 90°, 180°, and 270°, that is, five Fourier transform images in total. In other words, when each of the deflection coils 9a and 9b includes n-coils which generate dipole fields, it is only necessary to obtain two Fourier transform images at each orientation angle changed by (180/n)°, with the result that at least (2n+1) Fourier transform images in total are obtained.

A reference position for the orientation angle of 0° maybe arbitrarily set. When the number of Fourier transform images to be obtained is set too large, it is likely to lack memory capacity of the memory unit 43. Therefore, a maximum value of the number of Fourier transform images to be obtained is set in advance. When the number of Fourier transform images to be obtained exceeds the maximum value (NO in Step S108), for example, the processor 42 generates a message to this effect, so that the operator inputs the number of initial Fourier transform images to be obtained again (Step S107).

Therefore, the amount of beam shift, the amount of initial tilt of the electron beam, and the number of Fourier transform images to be obtained, which are received from the operator, are used to obtain scanning transmission images and produce Fourier transform images based thereon. Set values which are stored in the memory unit 43 in advance may be used instead of the amount of beam shift, the amount of initial tilt of the electron beam, and the number of Fourier transform images to be obtained, which are received from the operator.

The processor 42 operates the main body of the scanning transmission electron microscope based on the set values stored in the memory unit 43. First, the processor 42 controls the amount of current supplied to the deflection coils 9a and 9b to obtain a scanning transmission image of the specimen 12 using an electron beam tilted according to the amount of initial tilt before the beam shift. The scanning transmission image is stored in the memory unit 43. Next, the processor 42 controls the amount of current supplied to the deflection coils 9a and 9b based on each of orientation angles determined corresponding to the number of Fourier transform images to be obtained to obtain each scanning transmission image after the beam shift using an electron beam deflected according to the amount of beam shift and causes the memory unit 43 to store the obtained scanning transmission images (Step S110). Next, the processor 42 produces Fourier transform images from the scanning transmission image obtained before the beam shift and the scanning transmission images obtained after the beam shift at the respective orientation angles, which are stored in the memory unit 43 (Step S111). After that, as shown in FIG. 3C, the processor 42 generates display data in which the produced Fourier transform image are arranged in respective positions based on the amounts of beam shift and the orientation angles, and causes the user interface 22 to display the generated display data (Step S112). Note that a message indicating that the scanning transmission images are being obtained and the Fourier transform images are being produced may be sent to the operator through the user interface 22 while the scanning transmission images are being obtained and the Fourier transform images are being produced (Step S109).

A display manner of the Fourier transform images is not limited to that shown in FIG. 3C. The produced Fourier transform images may be arranged together with the scanning transmission images which are originals thereof in positions based on the amounts of beam shift and the orientation angles to generate display data. Alternatively, display data may be generated to display a set of images obtained under respective conditions in which orientation angles are different from each other by 180°.

Next, for example, the processor 42 causes the user interface 22 to display a message in order to request the operator to determine whether or not it is necessary to adjust the deflection coils 9a and 9b again based on the Fourier transform images of the display data (Step S113).

When an instruction indicating that it is not necessary to adjust the deflection coils 9a and 9b again is received from the operator through the user interface 22 (NO in Step S113), the operation shifts to the observation mode (Step S114).

In the observation mode, the processor 42 operates the main body of the scanning transmission electron microscope based on the set values stored in the memory unit 43 in order to observe the scanning transmission images of the specimen 12. A result obtained by observation is stored as a digital image file in the memory unit 43.

On the other hand, when an instruction indicating that it is necessary to adjust the deflection coils 9a and 9b again is received from the operator through the user interface 22 (YES in Step S113), the operation returns to Step S103 and moves to the deflection coil adjustment mode again. Examples of methods in which the deflection ratio is adjusted at this time include a method in which the excitation of the upper deflection coil 9a is held constant and only the excitation of the lower deflection coil 9b is changed, and a method in which the excitation of the lower deflection coil 9b is held constant and only the excitation of the upper deflection coil 9a is changed. In the processor 42, the deflection coil adjustment mode may be stopped to move the observation mode based on an instruction received from the operator through the user interface 22.

Next, the interactive screen used during the operation flow shown in FIG. 6 will be described.

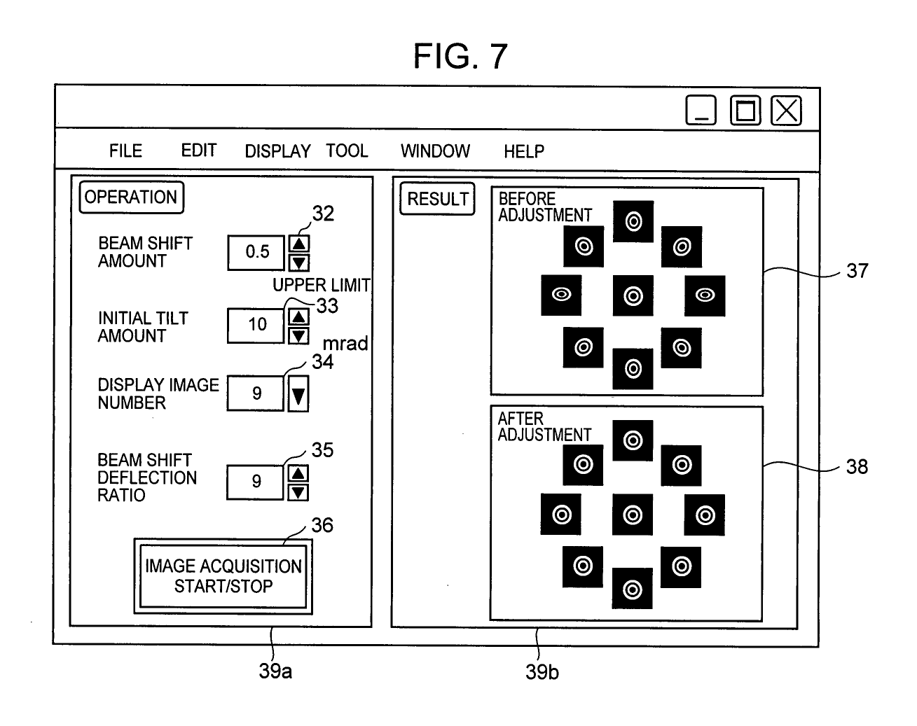

FIG. 7 shows an example of the interactive screen used during the operation flow shown in FIG. 6. As shown in FIG. 7, the interactive screen is divided into an operation reception area 39a and a result display area 39b.

The operation reception area 39a includes a text box 32 for inputting the amount of beam shift to be adjusted, a text box 33 for inputting the amount of initial tilt of the electron beam, a pull-down menu 34 for selecting the number of Fourier transform images to be obtained, a text box 35 for inputting the deflection ratio between the upper and lower deflection coils for the beam shift, and a button 36 which instructs the start and stop of the adjustment. A deflection ratio set as a default is displayed on the text box 35 to which the deflection ratio between the upper deflection coil 9a and the lower deflection coil 9b are input.

Upon receiving adjustment conditions from the operator through the operation reception area 39a, the processor 42 executes Steps 102 to S108 shown in FIG. 6. When the button 36 is selected, the processor 42 causes the memory unit 43 to store, as the set adjustment conditions, the amount of beam shift, the amount of initial tilt of the electron beam, the number of Fourier transform images to be obtained, and the deflection ratio between the deflection coils which are displayed on the text box 32, the text box 33, the pull-down menu 34, and the text box 35, respectively. After that, the processor 42 starts to execute Step S109 and the subsequent steps as shown in FIG. 6, thereby obtaining the Fourier transform images. At this time, a dialog box for reporting that the Fourier transform images are being produced is displayed on the interactive screen (Step S109 in FIG. 6). When the button 36 is pressed again while the Fourier transform images are being produced, the acquisition of the Fourier transform images can be stopped.

After the acquisition of the Fourier transform images is completed, display data 37 including the plurality of Fourier transform images obtained before and after the beam shift is displayed on an upper portion of the result display area 39b by the processor 42. The operator determines whether or not the deflection ratio is sufficiently adjusted based on degree of agreement between the displayed Fourier transform images which are obtained before and after the beam shift and included in the display data 37. When it is determined that the sufficient adjustment is not performed, the deflection ratio in the text box 35 is set again and the button 36 is pressed again. Therefore, the processor 42 starts to execute Step S109 and the subsequent steps as shown in FIG. 6 again, thereby obtaining Fourier transform images. Display data 38 including the plurality of Fourier transform images obtained before and after the beam shift again is displayed on a lower portion of the result display area 39b by the processor 42. The operator compares the Fourier transform images with one another to determine whether or not the deflection ratio is sufficiently adjusted. When it is determined that the adjustment is not sufficient, the deflection ratio in the text box 35 is set again and the button 36 is pressed again. Therefore, a display position of the display data including the previously obtained Fourier transform images is shifted from the upper portion of the result display area 39b to the lower portion thereof. The display data including the currently obtained Fourier transform images is displayed on the lower portion of the result display area 39b.

In order to perform more quantitative adjustment, a numeral value indicating degree of adjustment may be displayed on the interactive screen. In view of the characteristic that the ring pattern of each of the Fourier transform images obtained before and after the beam shift is a perfect circle where a suitable deflection ratio is set (see FIGS. 3C), examples of a numeral value indicating the degree of adjustment include a cross correlation coefficient and a phase correlation coefficient, each of which indicates the degree of agreement between Fourier transform images obtained after and before the beam shift. In view of the fact that the ring pattern of the Fourier transform image obtained after the beam shift becomes elliptical in the case where a suitable excitation is not set, an ellipticity of a specific ring of the ring pattern can be also used as the numeral value indicating the degree of adjustment. The ellipticity of the specific ring is measured as follows. For example, the Fourier transform image is processed by smoothing, binarization, or the like. Next, a maximum radial value and a minimum radial value on a line corresponding to each ring, which is obtained by polar coordinate conversion, are measured.

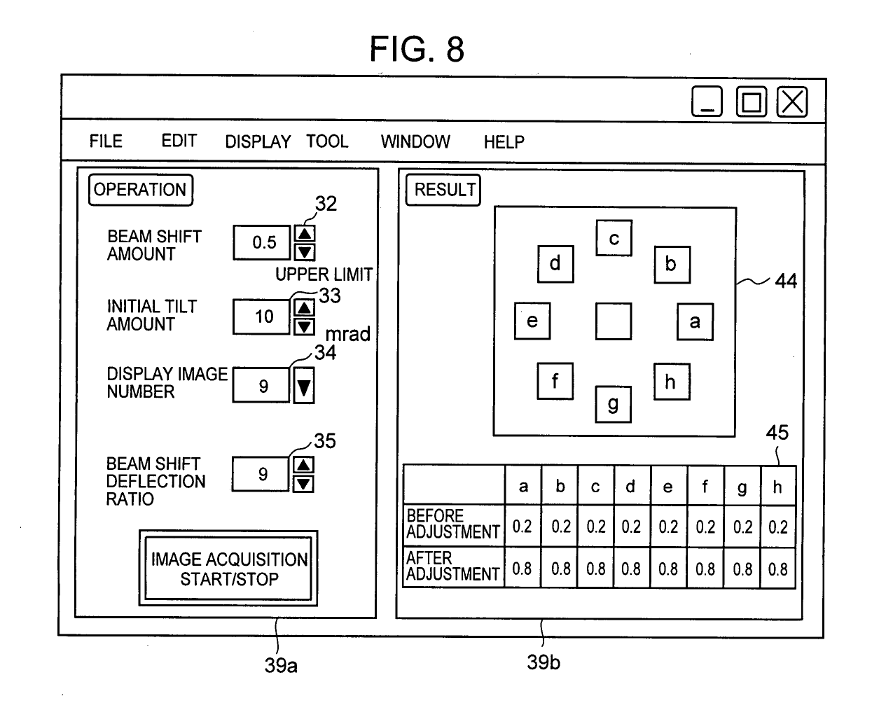

FIG. 8 shows an example of the interactive screen in which the degree of agreement between the Fourier transform images obtained after and before the beam shift is used for result display. As shown in FIG. 8, the interactive screen is divided into an operation reception area 39a and a result display area 39b. The operation reception area 39a is identical to that of the interactive screen shown in FIG. 7.

The result display area 39b includes a schematic chart 44 in which acquisition area positions of respective scanning transmission images obtained after the beam shift are expressed by symbols, and a table 45 indicating the degree of agreement between the Fourier transform image obtained before the beam shift and each of the Fourier transform images obtained after the beam shift, at the acquisition area positions corresponding to the symbols. Examples of the degree of agreement which is shown in the table 45 and to be used include: the cross correlation coefficient or the phase correlation coefficient between the Fourier transform image obtained before the beam shift, and each of the Fourier transform images obtained after the beam shift, at the acquisition area positions corresponding to the symbols; and the ellipticity of the specific ring of each of the Fourier transform images obtained after the beam shift, at the acquisition area positions corresponding to the symbols.

Upon receiving adjustment conditions from the operator through the operation reception area 39a, the processor 42 executes Steps 102 to S108 shown in FIG. 6. When the button 36 is selected, the processor 42 causes the memory unit 43 to store, as the set adjustment conditions, the amount of beam shift, the amount of initial tilt of the electron beam, the number of Fourier transform images to be obtained, and the deflection ratio between the deflection coils which are displayed on the text box 32, the text box 33, the pull-down menu 34, and the text box 35, respectively. After that, the processor 42 starts to execute Step S109 and the subsequent steps as shown in FIG. 6, thereby obtaining the Fourier transform images. At this time, the dialog box for reporting that the Fourier transform images are being produced is displayed on the interactive screen (Step S109 of FIG. 6). When the button 36 is pressed again while the Fourier transform images are being produced, the acquisition of the Fourier transform images can be stopped.

After the acquisition of the Fourier transform images is completed, the degree of agreement (degree of adjustment) between the Fourier transform image obtained before the beam shift and each of the Fourier transform images obtained after the beam shift at the respective acquisition area positions is displayed on an upper column of the table 45 by the processor 42. The operator determines whether or not the deflection ratio is sufficiently adjusted based on the degree of agreement. When it is determined that the sufficient adjustment is not performed, the deflection ratio in the text box 35 is set again and the button 36 is pressed again. Therefore, the processor 42 starts to execute Step S109 and the subsequent steps as shown in FIG. 6 again, thereby obtaining Fourier transform images. The degree of agreement between the Fourier transform image obtained before the beam shift, and each of Fourier transform images obtained after the beam shift, at the respective acquisition area positions is displayed on a lower column of the table 45 by the processor 42. The operator performs a comparison of the degree of agreement to determine whether or not the deflection ratio is sufficiently adjusted. When it is determined that the sufficient adjustment is not performed, the deflection ratio in the text box 35 is set again and the button 36 is pressed again. Therefore, a display position of the degree of agreement related to each of the previously obtained Fourier transform images is shifted from the lower column of the table 45 to the upper column thereof. The degree of agreement related to each of the currently obtained Fourier transform images is displayed on the lower column of the table 45. It is preferable that a value determined to be sufficient for observation be displayed as a reference value of the degree of agreement. A value indicating the degree of agreement between the Fourier transform images obtained before and after the beam shift may be displayed on the result display area 39b together with the display data including the Fourier transform images obtained before and after the beam shift for each of the acquisition areas expressed by the symbols in the schematic chart 44.

### Second Embodiment

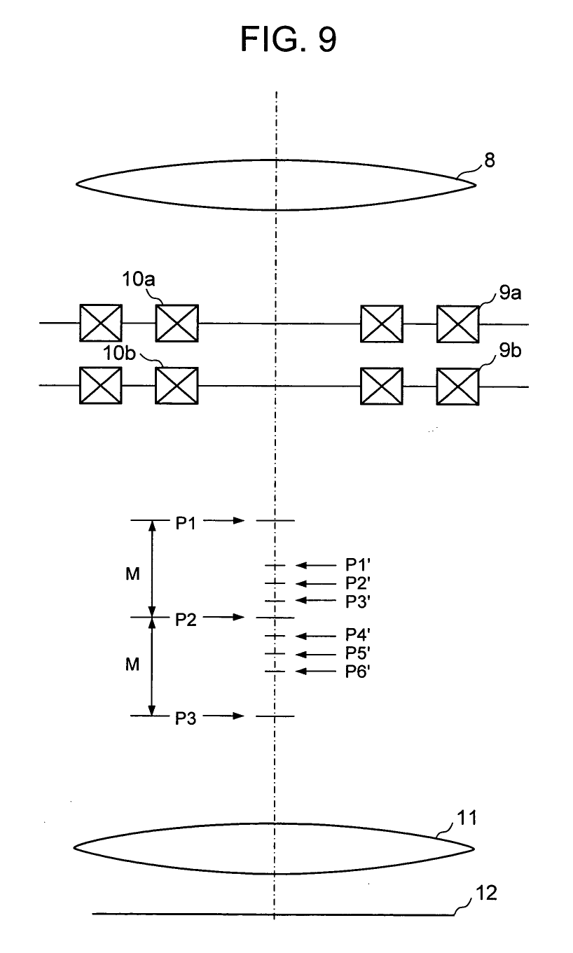

In this embodiment, as against the first embodiment, for example, deflection fulcrums P1, P2, and P3 are set as shown in FIG. 9. Therefore, the operator can select a suitable set from a plurality of sets of Fourier transform images (display data) obtained at each of deflection ratios satisfying respective conditions. The schematic configuration of a scanning transmission electron microscope according to this embodiment is identical to that of the first embodiment as shown in FIG. 1.

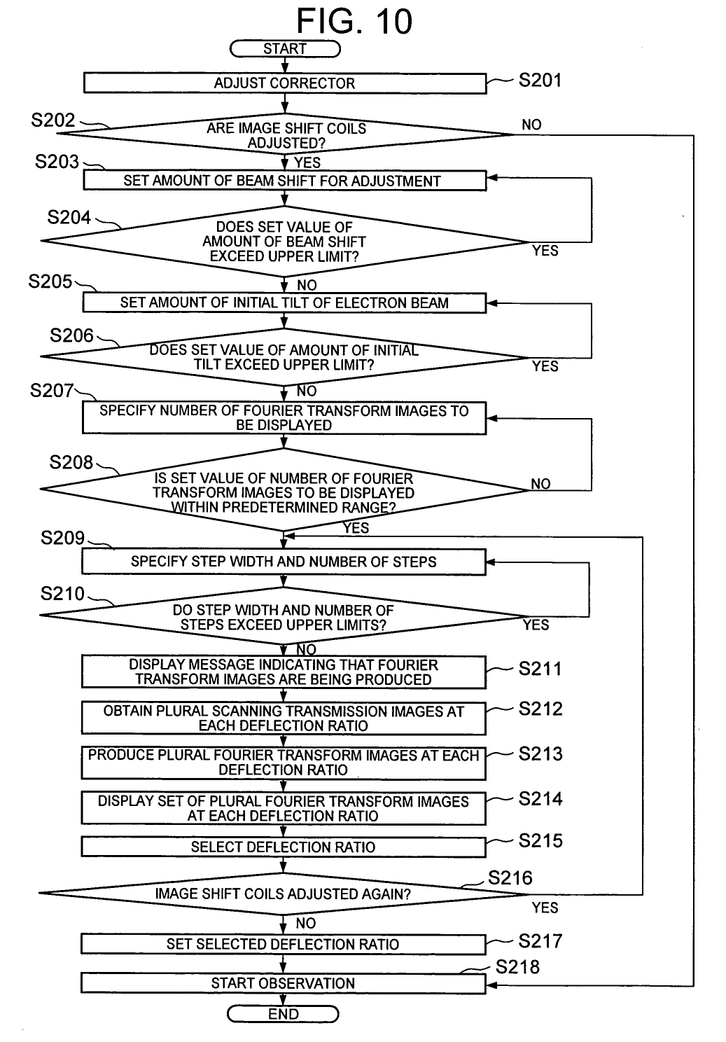

FIG. 10 is an explanatory flowchart showing an operation flow, where the deflection ratio between the upper deflection coil 9a and the lower deflection coil 9b is adjusted in the scanning transmission electron microscope according to the second embodiment of the present invention.

Processing of Step S201 to S208 is identical to the processing of Step S101 to S108 as shown in FIG. 6. In this embodiment, the processor 42 further receives, from the operator through the interactive screen, a step width (between deflection fulcrums) corresponding to a distance M between two adjacent deflection fulcrums P1, P2, and P3, as shown in FIG. 9, and the total number of deflection fulcrum steps for determining the number of deflection fulcrums, and causes the memory unit 43 to store the step width and the total number of steps (Step S209). Note that a center deflection fulcrum for setting the step width and the total number of steps may be stored in the memory unit 43 in advance or received from the operator through the interactive screen. A maximum value of the step width and a maximum value of the total number of steps are set in advance. When the received step width and the received total number of steps exceeds the maximum values (YES in Step S210), for example, the processor 42 generates a message indicating that the received step width and the received total number of steps exceeds the maximum values, so the operator inputs the step width and the total number of steps again (Step S209).

Therefore, the amount of beam shift, the amount of initial tilt of the electron beam, the number of Fourier transform images to be obtained, the step width between the deflection fulcrums, and the number of steps of the deflection fulcrums, which are received from the operator, are used to obtain scanning transmission images at a plurality of deflection ratios and produce Fourier transform images based thereon.

The processor 42 obtains a plurality of deflection fulcrums relative to a predetermined deflection fulcrum based on the step width between the deflection fulcrums and the total number of steps of the deflection fulcrums. Next, the processor 42 calculates a plurality of deflection ratios for realizing the obtained plurality of deflection fulcrums using a known method. After that, a set of a plurality of scanning transmission images is produced at each of the calculated deflection ratios. Specifically, the main body of the scanning transmission electron microscope is operated based on the set values stored in the memory unit 43. The amount of current supplied to each of the deflection coils 9a and 9b is controlled to obtain any one of the calculated deflection ratios. A scanning transmission image of the specimen 12 is obtained using an electron beam tilted according to the amount of initial tilt before the beam shift. The scanning transmission image is stored in the memory unit 43. Next, the amount of current supplied to each of the deflection coils 9a and 9b is controlled to obtain the deflection ratio at each of orientation angles determined corresponding to the number of Fourier transform images to be obtained. Each scanning transmission image is obtained after the beam shift using an electron beam deflected according to the amount of beam shift. The obtained scanning transmission images are stored in the memory unit 43. Such processing is performed for each of the calculated deflection ratios to produce the set of the plurality of scanning transmission image before and after the beam shift at each of the deflection ratios (Step S212).

Next, the processor 42 produces Fourier transform images from a scanning transmission image obtained before the beam shift and scanning transmission images obtained after the beam shift at orientation angles in the set of the plurality of scanning transmission image before and after the beam shift at each of the deflection ratios stored in the memory unit 43 (Step S213). The processor 42 generates display data including a set of a plurality of Fourier transform images produced before and after the beam shift for each of the deflection ratios and causes the user interface 22 to display the generated display data (Step S214). Note that the message indicating that the scanning transmission images are being obtained and the Fourier transform images are being produced may be sent to the operator through the user interface 22 while the scanning transmission images are being obtained and the Fourier transform images are being produced (Step S211).

Next, the processor 42 requests the operator to select display data associated with a suitable deflection ratio from the multiple items of display data associated with the deflection ratios, which are displayed on the user interface 22 (Step S215). After that, for example, the processor 42 causes the user interface 22 to display a message in order to request the operator to determine whether or not it is necessary to adjust the deflection coils 9a and 9b again based on the Fourier transform images of the display data selected by the operator in Step S125 (Step S216).

When the instruction indicating that it is not necessary to adjust the deflection coils 9a and 9b is received from the operator through the user interface 22 (NO in Step S216), the deflection ratio related to the display data selected by the operator in Step S215 is stored as an adjustment value of the deflection coils 9a and 9b in the memory unit 43 (Step S217). Next, the operation shifts to the observation mode (Step S218). In the observation mode, the processor 42 operates the main body of the scanning transmission electron microscope based on the set values stored in the memory unit 43 in order to observe the scanning transmission images of the specimen 12. A result obtained by observation is stored as a digital image file in the memory unit 43.

On the other hand, when the instruction indicating that it is necessary to adjust the deflection coils 9a and 9b again is received from the operator through the user interface 22 (YES in Step S216), the operation shifts to the deflection coil adjustment mode again. Next, processing of Step S209 (reception of step width between deflection fulcrums and the total number of steps of deflection fulcrums) and subsequent steps are repeated. The step width between the deflection fulcrums and the total number of steps of the deflection fulcrums at this time are changed as follows. An upper limit value of the step width is changed to a value smaller than the above-mentioned distance between the deflection fulcrums. After that, as shown in FIG. 9, a plurality of deflection fulcrums P1′ to P6′ is set based on the step width between the deflection fulcrums and the total number of steps of the deflection fulcrums which are received again. The center point between the deflection fulcrums P1′ and P6′ corresponds to the deflection fulcrum P2 corresponding to the display data selected by the operator in Step S215. Accordingly, the deflection ratio an bead justed with higher precision. The above-mentioned procedure is repeated until the operator determines that the deflection coils 9a and 9b are sufficiently adjusted.

Next, the interactive screen used during the operation flow shown in FIG. 10 will be described.

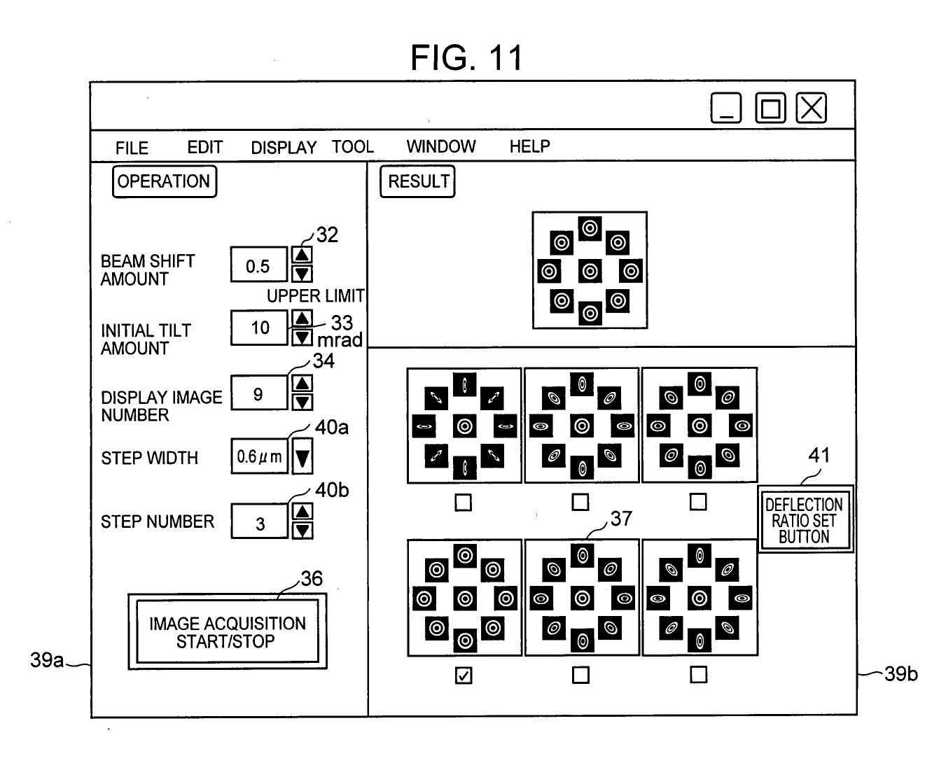

FIG. 11 shows an example of the interactive screen used during the operation flow shown in FIG. 10. As shown in FIG. 11, the interactive screen is identical to that shown in FIG. 7 and divided into the operation reception area 39a and the result display area 39b.

The operation reception area 39a includes the text box 32 which is used for inputting the amount of beam shift to be adjusted, the text box 33 which is used for inputting the amount of initial tilt of the electron beam, the pull-down menu 34 which is used for selecting the number of Fourier transform images to be obtained, a text box 40a which is used for inputting the step width between the deflection fulcrums, a text box 40b which is used for inputting the total number of steps, and the button 36 which is used for instructing the start and stop of the adjustment.

Upon receiving adjustment conditions from the operator through the operation reception area 39a, the processor 42 executes Steps S202 to S210 shown in FIG. 10. When the button 36 is selected, the processor 42 causes the memory unit 43 to store, as the set adjustment conditions, the amount of beam shift, the amount of initial tilt of the electron beam, the number of Fourier transform images to be obtained, the step width between the deflection fulcrums, and the total number of steps which are displayed on the text box 32, the text box 33, the pull-down menu 34, the text box 40a, and the text box 40b, respectively. After that, the processor 42 starts to execute Step S211 and the subsequent steps as shown in FIG. 10, thereby obtaining the plurality of Fourier transform images before and after the beam shift for each deflection ratio corresponding to each of the plurality of deflection fulcrums specified by the step width and the total number of steps. Therefore, the total number of Fourier transform images to be obtained becomes (the number of images to be obtained)×(the number of steps). At this time, the dialog box for reporting that the Fourier transform images are being produced is displayed on the interactive screen (Step S211 of FIG. 10). When the button 36 is pressed again while the Fourier transform images are being produced, the acquisition of the Fourier transform images can be stopped.

After the acquisition of the Fourier transform images is completed, multiple items of display data 37, each of which includes the plurality of Fourier transform images obtained before and after the beam shift at each deflection ratio corresponding to each of the plurality of deflection fulcrums specified by the step width and the total number of steps, are displayed on a lower portion of the result display area 39b by the processor 42. When the operator checks a check box of display data in which the degree of agreement between the Fourier transform images before and after the beam shift is highest, of the multiple items of display data 37, the corresponding item of display data 37 is displayed on an upper portion of the result display area 39b. The operator determines whether or not the deflection ratio is sufficiently adjusted based on the degree of agreement between the Fourier transform images which are obtained before and after the beam shift and included in the display data 37 displayed on the upper portion of the result display area 39b. When it is determined that the adjustment is not sufficient, the step width and the total number of steps in the text boxes 40a and 40b are set again and the button 36 is pressed again. Therefore, the processor 42 starts to execute Step S211 and the subsequent steps as shown in FIG. 10 again, thereby obtaining Fourier transform images. On the other hand, when it is determined that the adjustment is sufficient, a deflection ratio set button 41 is pressed. Therefore, the processor 42 starts to execute Step S218 as shown in FIG. 10 and moves to the observation mode.

### Third Embodiment

In this embodiment, as against the first embodiment, the deflection ratio between the deflection coils 9a and 9b are automatically adjusted. Therefore, the processor 42 determines whether or not the degree of adjustment is suitable based on the plurality of Fourier transform images obtained before and after the beam shift. The schematic configuration of a scanning transmission electron microscope according to this embodiment is identical to that in the first embodiment as shown in FIG. 1.

In this embodiment, a deflection ratio between two dipole coils composing the deflection coils 9a and 9b is determined. Hereinafter, the case where the deflection coils 9a and 9b include two dipoles orthogonal to each other will be described.

First, a scanning transmission image is obtained without performing the beam shift and a Fourier transform image is produced therefrom. Next, the beam shift is performed by exciting only one of two dipole components composing the deflection coils 9a and 9b.

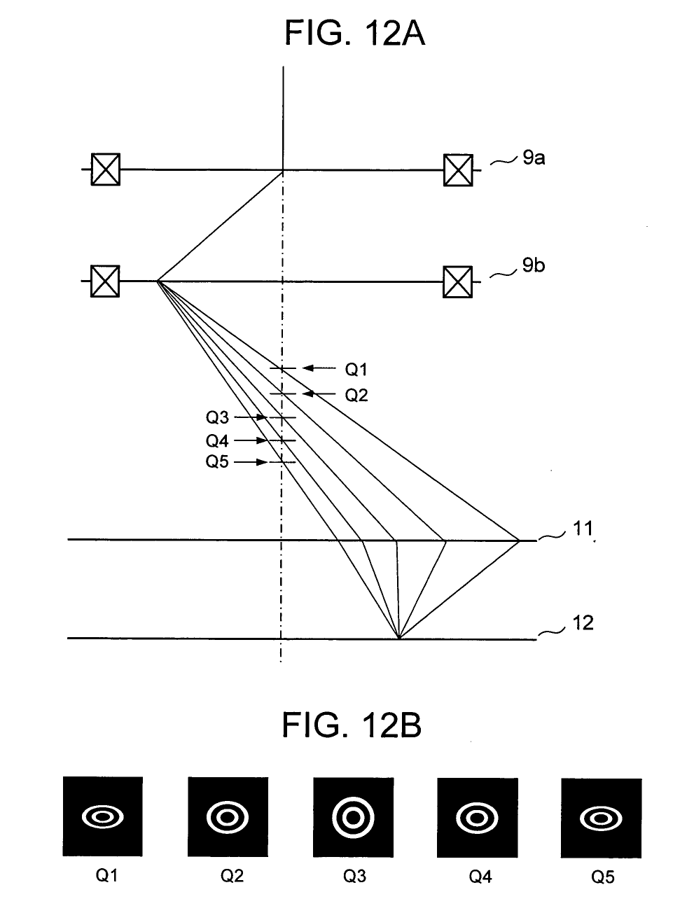

Next, as shown in FIG. 12A, a deflection ratio between the upper deflection coil 9a and lower deflection coil 9b is set corresponding to each of a plurality of deflection fulcrums Q1 to Q5. Scanning transmission images are obtained at respective deflection ratios. Fourier transform images associated with the respective deflection ratios are produced based on the respective scanning transmission images. Here, assume that the deflection ratio corresponding to, for example, the deflection fulcrum Q3 is close to a suitable deflection ratio. In this case, as shown in FIG. 12B, each of the Fourier transform images, produced at the respective deflection ratios corresponding to the deflection fulcrums Q1 to Q5, has a concentric ring pattern. In particular, the Fourier transform image related to the deflection fulcrum Q3 has a concentric ring pattern closest to a perfect circle. Therefore, when a suitable deflection ratio condition is to be determined by the processor 42 based on the obtained Fourier transform images, it is only necessary to detect a Fourier transform image whose ring pattern is closest to the perfect circle by pattern matching or the like. Alternatively, the suitable deflection ratio condition may be determined by comparing, with a predetermined threshold, the cross correlation coefficient or the phase correlation coefficient between the Fourier transform images obtained before and after the beam shift or the ellipticity of the specific ring in a ring pattern obtained after the beam shift.

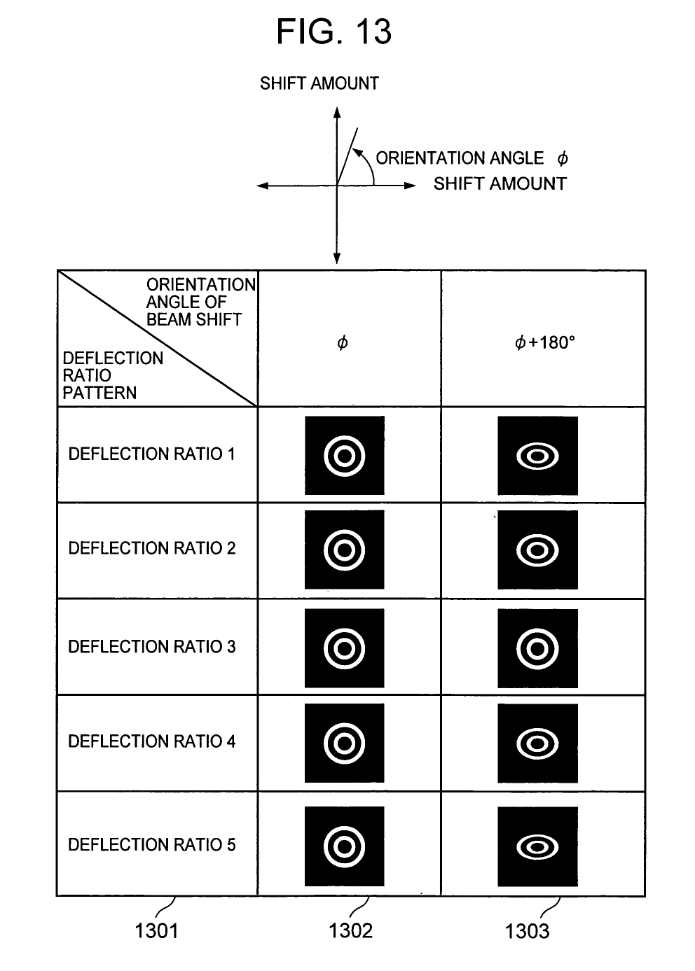

As described above, in the case where the beam tilt component is included by the beam shift, even when a Fourier transform image having the concentric ring pattern closest to the perfect circle is obtained by the beam shift in a direction indicated by an orientation angle φ, the ring pattern of the Fourier transform image is deformed by the beam shift in are verse direction (orientation angle φ+180°) in some cases. Therefore, in this embodiment, the beam shift is performed in the direction indicated by the orientation angle φ. After that, the beam shift is performed in the reverse direction (orientation angle φ+180°). The scanning transmission images are obtained in the respective directions of the beam shift to produce the Fourier transform images. The cross correlation coefficient, the phase correlation coefficient, or the ellipticity is obtained based on the Fourier transform images produced before and after the beam shift. Next, a deflection ratio where the cross correlation coefficient, the phase correlation coefficient, or the ellipticity is a most suitable value (the degree of agreement is high or the ring pattern is close to the perfect circle) is selected. FIG. 13 shows a set of a Fourier transform images obtained where the beam shift is performed in the direction indicated by the orientation angle φ and a Fourier transform image obtained where the beam shift is performed in the direction indicated by the orientation angle φ+180°, for each deflection ratio employed for the beam shift. An entry 1301 shows deflection ratios. An entry 1302 shows Fourier transform images obtained where the beam shift is performed in the direction indicated by the orientation angle φ. An entry 1303 shows Fourier transform images obtained where the beam shift is performed in the direction indicated by the orientation angle φ+180°. In an example shown in FIG. 13, the deflection ratio “3” where a set of Fourier transform images have a shape close to the perfect circle, without depending on the direction indicated by the orientation angle of the beam shift, is selected.

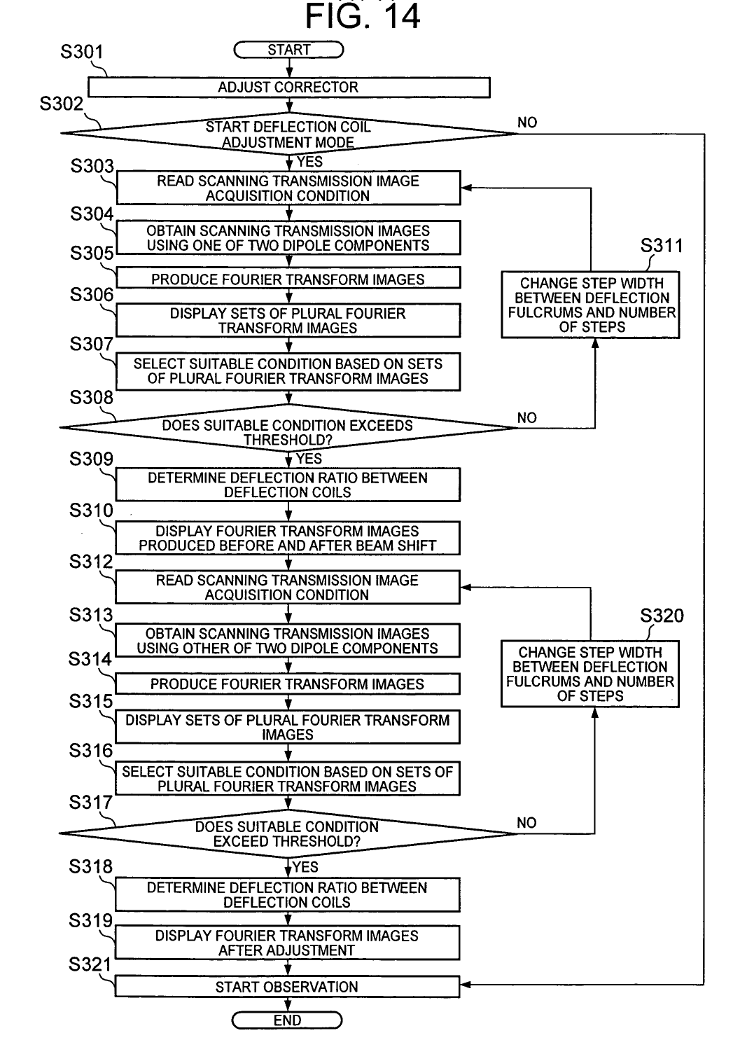

FIG. 14 is an explanatory flowchart showing an operation flow where the deflection ratio between the upper deflection coil 9a and the lower deflection coil 9b is adjusted in the scanning transmission electron microscope according to the third embodiment of the present invention.

The spherical aberration corrector is adjusted first (Step S301). For example, the operator operates an attachment mechanism (not shown) of the spherical aberration corrector 7 to adjust the optical axis of the spherical aberration corrector 7. In addition, the operator sets an excitation value for the spherical aberration corrector 7 to the information processing device 24 through the user interface 22. When the excitation value for the spherical aberration corrector 7 is set by the operator through the user interface 22, for example, the processor 42 of the information processing device 24 causes the user interface 22 to display a message to request the operator to determine whether or not it is necessary to adjust the deflection coils 9a and 9b (Step S302).

When the instruction indicating that it is not necessary to adjust the deflection coils 9a and 9b is received from the operator through the user interface 22 (NO in Step S302), the operation immediately shifts to the observation mode (Step S321). In the observation mode, the processor 42 operates the main body of the scanning transmission electron microscope based on set values stored in the memory unit 43 to observe the scanning transmission images of the specimen 12. A result obtained by observation is stored as a digital image file in the memory unit 43.

On the other hand, when the instruction indicating that it is necessary to adjust the deflection coils 9a and 9b is received from the operator through the user interface 22 (YES in Step S302), the operation shifts to the deflection coil adjustment mode.

In the deflection coil adjustment mode, the processor 42 reads the amount of beam shift for the electron beam, the amount of initial tilt of the electron beam, the number of Fourier transform images to be obtained, the step width between the deflection fulcrums, and the total number of steps of the deflection fulcrums, which are stored in the memory unit 43 in advance (Step S303).

Next, the processor 42 controls only one (for example, the deflection coil 9a) of the two deflection coils 9a and 9b (dipole components) based on the amount of beam shift, the amount of initial tilt of the electron beam, the number of Fourier transform images to be obtained, the step width between the deflection fulcrums, and the total number of steps of the deflection fulcrums, which are read from the memory unit 43. Therefore, scanning transmission images are obtained at a plurality of deflection ratios and Fourier transform images are produced therefrom.

The processor 42 obtains a plurality of deflection fulcrums relative to a predetermined deflection fulcrum based on the step width between the deflection fulcrums and the total number of steps of the deflection fulcrums. Next, the processor 42 calculates a plurality of deflection ratios for realizing the obtained plurality of deflection fulcrums using a known method. After that, a set of a plurality of scanning transmission images is produced at each of the calculated deflection ratios by controlling one of the two deflection coils 9a and 9b. Specifically, the main body of the scanning transmission electron microscope is operated based on the set values stored in the memory unit 43. The amount of current supplied to the one of the deflection coils 9a and 9b is controlled to obtain any one of the calculated deflection ratios. A scanning transmission image of the specimen 12 before the beam shift is obtained using an electron beam tilted according to the amount of initial tilt. The scanning transmission image is stored in the memory unit 43. Next, the amount of current supplied to the one of the deflection coils 9a and 9b is controlled so as to obtain the deflection ratio at each of orientation angles determined corresponding to the number of Fourier transform images to be obtained. Each scanning transmission image after the beam shift is obtained using an electron beam deflected according to the amount of beam shift. The obtained scanning transmission images are stored in the memory unit 43. Such processing is performed for each of the calculated deflection ratios to produce the set of the plurality of scanning transmission image before and after the beam shift at each of the deflection ratios (Step S304).

Next, the processor 42 produces Fourier transform images from a scanning transmission image obtained before the beam shift and scanning transmission images obtained after the beam shift at respective orientation angles in the set of the plurality of scanning transmission images before and after the beam shift at each of the deflection ratios realized by the control of the one of the deflection coils 9a and 9b, which are stored in the memory unit 43 (Step S305). After that, the processor 42 generates display data including a set of a plurality of Fourier transform images produced before and after the beam shift for each of the deflection ratios and causes the user interface 22 to display the generated display data (Step S306).

Next, the processor 42 calculates, using the above-mentioned method, a cross correlation coefficient or a phase correlation coefficient between ring patterns obtained before and after the beam shift, or an ellipticity of a ring pattern after the beam shift, in the set of the plurality of Fourier transform images produced before and after the beam shift for each of the deflection ratios. After that, the processor 42 selects a cross correlation coefficient or a phase correlation coefficient indicating the highest degree of agreement between the ring patterns obtained before and after the beam shift or an ellipticity indicating highest circularity (Step S307).

Next, the processor 42 determines whether or not the selected one of the cross correlation coefficient, the phase correlation coefficient, and the ellipticity exceeds a threshold stored in the memory unit 43 in advance (Step S308).

When the one of the cross correlation coefficient, the phase correlation coefficient, and the ellipticity which is selected in Step S307 does not exceed the threshold (NO in Step S308), it is determined that the one of the deflection coils 9a and 9b is not sufficiently adjusted, and the step width between the deflection fulcrums and the total number of steps the deflection fulcrums are changed based on a predetermined rule stored in the memory unit 43 (Step S311). Specifically, the step width is narrowed by a predetermined amount. The total number of steps is increased based on a predetermined rule. For example, when the step width between the deflection fulcrums and the total number of steps of the deflection fulcrums in the preceding adjustment are expressed by “a” and “b”, respectively, and when the step width between the deflection fulcrums in the current adjustment is expressed by “c”, the total number of steps of the deflection fulcrums (“d”) in the current adjustment is expressed by (a×b)/c. Next, the operation returns to Step S303 and the processor 42 obtains scanning transmission images again and produces Fourier transform images based thereon again. When a plurality of deflection fulcrums is to be obtained from the step width between the deflection fulcrums and the total number of steps of the deflection fulcrums in Step S304, the plurality of deflection fulcrums is calculated relative to a deflection fulcrum corresponding to a deflection ratio related to the set of the Fourier transform images in which the one of the cross correlation coefficient, the phase correlation coefficient, and the ellipticity which is selected in Step S307 is calculated.

On the other hand, when the one of the cross correlation coefficient, the phase correlation coefficient, and the ellipticity which is selected in Step S307 exceeds the threshold (YES in Step S308), it is determined that the one of the deflection coils 9a and 9b is sufficiently adjusted. In cases where the set of the Fourier transform images, in which the one of the cross correlation coefficient, the phase correlation coefficient, and the ellipticity selected in Step S307 is calculated, are obtained, the amount of current supplied to the one of the deflection coils 9a and 9b is determined as the amount of current supplied to the one of the deflection coils 9a and 9b used for the observation mode. The determined amount of current is stored in the memory unit 43 (Step S309). The display data and/or the cross correlation coefficient, the phase correlation coefficient, or the ellipticity in the set of the Fourier transform images is displayed on the user interface 22 (Step S310).

Next, the processor 42 reads the amount of beam shift for the electron beam, the amount of initial tilt of the electron beam, the number of Fourier transform images to be obtained, the step width between the deflection fulcrums, and the total number of steps of the deflection fulcrums, which are stored in the memory unit 43 in advance, and the amount of current supplied to the one (for example, the deflection coil 9a) of the deflection coils 9a and 9b which is stored in the memory unit 43 in Step S309 (Step S312).

Next, the processor 42 controls only the other (for example, the deflection coil 9b) of the two deflection coils 9a and 9b based on the amount of beam shift, the amount of initial tilt of the electron beam, the number of Fourier transform images to be obtained, the step width between the deflection fulcrums, and the total number of steps of the deflection fulcrums, and the amount of current supplied to the one (for example, the deflection coil 9a) of the deflection coils 9a and 9b, which read from the memory unit 43. Therefore, scanning transmission images are obtained at a plurality of deflection ratios and Fourier transform images are produced therefrom.

The processor 42 obtains a plurality of deflection fulcrums relative to a predetermined deflection fulcrum based on the step width between the deflection fulcrums and the total number of steps of the deflection fulcrums. Next, the processor 42 calculates a plurality of deflection ratios for realizing the obtained plurality of deflection fulcrums using a known method. After that, at each of the calculated deflection ratios, the amount of current supplied to the one of the two deflection coils 9a and 9b is held constant at the amount of current stored in the memory unit 43 in Step S309, and the amount of current supplied to the other of the two deflection coils 9a and 9b is controlled, thereby producing a set of a plurality of scanning transmission images. Specifically, the main body of the scanning transmission electron microscope is operated based on the set values stored in the memory unit 43. The amount of current supplied to the one of the two deflection coils 9a and 9b is held constant at the amount of current stored in the memory unit 43 in Step S309. The amount of current supplied to the other of the deflection coils 9a and 9b is controlled so as to obtain any one of the calculated deflection ratios. A scanning transmission image of the specimen 12 before the beam shift is obtained using an electron beam tilted according to the amount of initial tilt. The scanning transmission image is stored in the memory unit 43. Next, the amount of current supplied to the other of the deflection coils 9a and 9b is controlled to obtain the deflection ratio at each of orientation angles determined corresponding to the number of Fourier transform images to be obtained. Each scanning transmission image, after the beam shift, is obtained using an electron beam deflected according to the amount of beam shift. The obtained scanning transmission images are stored in the memory unit 43. Such processing is performed for each of the calculated deflection ratios to produce the set of the plurality of scanning transmission image before and after the beam shift at each of the deflection ratios (Step S313).

Next, the processor 42 produces Fourier transform images from a scanning transmission image obtained before the beam shift and scanning transmission images obtained after the beam shift at respective orientation angles in the set of the plurality of scanning transmission image obtained before and after the beam shift at each of the deflection ratios realized by the control of the other of the deflection coils 9a and 9b, which are stored in the memory unit 43 (Step S314). After that, the processor 42 generates display data including a set of a plurality of Fourier transform images produced before and after the beam shift for each of the deflection ratios and causes the user interface 22 to display the generated display data (Step S315).

Next, the processor 42 calculates, using the above-mentioned method, a cross correlation coefficient or a phase correlation coefficient between ring patterns obtained before and after the beam shift or an ellipticity of a ring pattern after the beam shift in the set of the plurality of Fourier transform images produced before and after the beam shift for each of the deflection ratios. After that, the processor 42 selects a cross correlation coefficient or a phase correlation coefficient indicating the highest degree of agreement between the ring patterns obtained before and after the beam shift or an ellipticity indicating highest circularity (Step S316).

Next, the processor 42 determines whether or not the selected one of the cross correlation coefficient, the phase correlation coefficient, and the ellipticity exceeds a threshold stored in the memory unit 43 in advance (Step S317).

When the one of the cross correlation coefficient, the phase correlation coefficient, and the ellipticity which is selected in Step S316 does not exceed the threshold (NO in Step S317), it is determined that the other of the deflection coils 9a and 9b is not sufficiently adjusted, the step width between the deflection fulcrums and the total number of steps of the deflection fulcrums are changed based on a predetermined rule stored in the memory unit 43 (Step S320). Specifically, the step width is narrowed by a predetermined amount. The total number of steps is increased based on a predetermined rule. For example, when the step width between the deflection fulcrums and the total number of steps of the deflection fulcrums in the preceding adjustment are expressed by “a” and “b” and the step width between the deflection fulcrums in the current adjustment is expressed by “c”, the total number of steps of the deflection fulcrums (“d”) in the current adjustment is expressed by (a×b)/c. Next, the operation returns to Step S312 and the processor 42 obtains scanning transmission images again and produces Fourier transform images based thereon again. When a plurality of deflection fulcrums are to be obtained from the step width between the deflection fulcrums and the total number of steps of the deflection fulcrums in Step S314, the plurality of deflection fulcrums are calculated relative to a deflection fulcrum corresponding to a deflection ratio related to the set of the Fourier transform images in which the one of the cross correlation coefficient, the phase correlation coefficient, and the ellipticity which is selected in Step S316 is calculated.

On the other hand, when the one of the cross correlation coefficient, the phase correlation coefficient, and the ellipticity, which is selected in Step S316, exceeds the threshold (YES in Step S317), it is determined that the other of the deflection coils 9a and 9b is sufficiently adjusted. In the cases where the set of the Fourier transform images, in which the one of the cross correlation coefficient, the phase correlation coefficient, and the ellipticity selected in Step S316 is calculated, are obtained, the amount of current supplied to the other of the deflection coils 9a and 9b is determined as the amount of current supplied to the other of the deflection coils 9a and 9b used for the observation mode. The determined amount of current is stored in the memory unit 43 (Step S318). The display data and/or the cross correlation coefficient, the phase correlation coefficient, or the ellipticity in the set of the Fourier transform images is displayed on the user interface 22 (Step S319). When additional scanning transmission images are obtained to produce Fourier transform images, an image in which Fourier transform images are arranged corresponding to the amounts of beam shift and the orientation angles may be displayed as shown in FIG. 3A.

Next, the processor 42 causes the user interface 22 to display a message indicating that the adjustment of the deflection coils is completed. When an observation start instruction is received from the operator trough the user interface 22, the operation shifts to the observation mode (Step S321). In the observation mode, the processor 42 operates the main body of the scanning transmission electron microscope based on the set values stored in the memory unit 43 to observe the scanning transmission images of the specimen 12. A result obtained by observation is stored as a digital image file in the memory unit 43.

In this embodiment, the deflector (deflection coils 9a and 9b) including the two dipole components is described. The present invention can be also applied to cases where the deflector includes three or more dipole components. A pattern including repeated figures such as circles, rectangles, or triangles, which are drawn on a substrate may be used as the standard specimen 12 to obtain the scanning transmission image for the Fourier transform image. Even when an image obtained by extracting only a spot shape of the electron beam from the scanning transmission image by a deconvolution method or a Ronchigram is used instead of the Fourier transform image, the adjustment can be performed.

In this embodiment, when the operator wants to use the image shift function, the deflection coils 9a and 9b are normally adjusted every time after the corrector 7 is adjusted. However, the suitable deflection ratio between the deflection coils 9a and 9b is determined based on an excitation condition of the corrector 7. Therefore, after the adjustment of the deflection coils 9a and 9b, a deflection ratio condition between the deflection coils 9a and 9b is stored in the memory unit 43 together with the current excitation condition of the corrector 7. When the excitation condition of the corrector 7 is identical to a past condition, it is possible to instantaneously adjust the deflection coils 9a and 9b with reference to a corresponding deflection ratio.

The embodiments of the present invention have been described.

The above-mentioned method which adjusts the deflection coils can be used for a scanning transmission electron microscope which does not include the spherical aberration corrector 7. The method can be used for a scanning transmission electron microscope including not only the spherical aberration corrector 7 but also a chromatic aberration corrector or a high-order corrector.

What is claimed is:

1. A scanning transmission electron microscope, comprising:
a specimen holder on which a specimen is placed;
an electron optics which scans the specimen placed on the specimen holder with an electron beam;
a detector which detects electrons passing through the specimen;
information processor which forms an image of the specimen based on an output signal from the detector;
image display means which displays the image formed by the information processor; and
electron optics controller which adjusts the electron optics; wherein
the electron optics includes:
a corrector; and
a deflector which shifts a position of the electron beam passing through the corrector; and
the information processor forms a first Fourier transform image corresponding to a scanning transmission image of the specimen based on an output signal from the detector when the position of the electron beam is shifted by the deflector, forms a second Fourier transform image corresponding to a scanning transmission image of the specimen based on an output signal from the detector when the position of the electron beam is not shifted, and causes the image display means to display the first Fourier transform image and the second Fourier transform image.

2. A scanning transmission electron microscope including an image shift function, comprising:
an electron optics including a corrector, an image shift deflector, and a scan deflector;
a specimen holder which holds a specimen to be observed;
a transmission detector which detects an electron beam passing through the specimen to be observed;
controller which controls the image shift deflector; and
information processor which forms a Fourier transform image corresponding to an image shift image based on an output signal from the transmission detector and generates display data using the Fourier transform image.

3. A scanning transmission electron microscope according to claim 1, wherein the Fourier transform image is obtained at each of a first position at which the electron beam is not shifted, a second position shifted from the first position by a predetermined amount, and a third position which is rotationally symmetrical to the second position, with the first position as center.

4. A scanning transmission electron microscope according to claim 2, wherein the Fourier transform image is obtained at each of a first position at which an image shift is not performed, a second position shifted from the first position by a predetermined amount, and a third position which is rotationally symmetrical to the second position, with the first position as center.

5. A scanning transmission electron microscope according to claim 3 or 4, wherein the rotation symmetrical position is a 2-fold rotation symmetrical position.

6. A scanning transmission electron microscope according to claim 5, wherein the Fourier transform image is respectively obtained at positions including a 4-fold rotation symmetrical position and a 6-fold rotation symmetrical position, in addition to the 2-fold rotation symmetrical position.

7. A scanning transmission electron microscope according to claim 1 or 2, wherein a Ronchigram image is used instead of the Fourier transform image.

8. A scanning transmission electron microscope according to claim 1, wherein the scanning transmission image is obtained using a standard specimen.

9. A scanning transmission electron microscope according to claim 8, wherein the standard specimen comprises one of an amorphous material, a gold particle located on a carbon film, a latex ball, a platinum particle, an aluminum particle, an Si particle, and a pattern including repeated figure shaving one of a circle, a rectangle, and a triangle, which are drawn on a substrate.

10. A scanning transmission electron microscope according to claim 1, further comprising information input means which sets the amount of shift.

11. A scanning transmission electron microscope, comprising:
a specimen holder on which a specimen is placed;
an electron optics which scans the specimen placed on the specimen holder with an electron beam;
a detector which detects electrons passing through the specimen;
information processor which forms an image of the specimen based on an output signal from the detector;
image display means which displays the image formed by the information processor; and
electron optics controller which adjusts the electron optics;
wherein
the electron optics includes:
a corrector; and
a deflector which shifts a position of the electron beam passing through the corrector; and
the information processor calculates the amount of adjustment of the deflector based on Fourier transform images corresponding to a plurality of scanning transmission images including a scanning transmission image of the specimen which is obtained after the position of the electron beam is shifted, and a scanning transmission image obtained without shifting the position of the electron beam, and transfers the calculated amount of adjustment to the electron optics controller.

12. A scanning transmission electron microscope according to claim 11, wherein the information processor calculates one of an ellipticity, a cross correlation coefficient, and a phase correlation coefficient, with respect to each of the plurality of Fourier transform images, and calculates the amount of adjustment of the deflector when the one of the ellipticity, the cross correlation coefficient, and the phase correlation coefficient becomes minimum in the plurality of Fourier transform images.

13. A scanning transmission electron microscope according to claim 12, wherein the image display means displays a numeral value of the one of the ellipticity, the cross correlation coefficient, and the phase correlation coefficient.

14. An adjusting method of a scanning transmission electron microscope including: a specimen holder on which a specimen is placed; an electron optics which scans the specimen placed on the specimen holder with an electron beam, the electron optics including a corrector and a deflector which shifts a position of the electron beam passing through the corrector; a detector which detects an electron passing through the specimen; information processor which forms an image of the specimen based on an output signal from the detector; and image display means which displays the image formed by the information processor,
the method comprising:
forming, by the information processor, a first Fourier transform image corresponding to a scanning transmission image of the specimen based on an output signal from the detector when the position of the electron beam is shifted by the deflector;
forming, by the information processor, a second Fourier transform image corresponding to a scanning transmission image of the specimen based on an output signal from the detector when the position of the electron beam is not shifted; and
displaying, by the information processor, the first Fourier transform image and the second Fourier transform image on the image display means.

15. An adjusting method of a scanning transmission electron microscope including an image shift function, comprising:
scanning, with an electron beam, a specimen to be observed which is held by a specimen holder, using an electron optics including a corrector, an image shift deflector, and a scan deflector;
detecting an electron beam passing through the specimen to be observed, using a transmission detector;
forming, using an information processing device, a Fourier transform image corresponding to an image-shifted image based on an output signal from the transmission detector which detects the electron beam passing through the specimen to be observed; and
generating display data using the formed Fourier transform image.

16. An adjusting method of a scanning transmission electron microscope including: a specimen holder on which a specimen is placed; an electron optics which scans the specimen placed on the specimen holder, with an electron beam, the electron optics including a corrector and a deflector which shifts a position of the electron beam passing through the corrector; a detector which detects electrons passing through the specimen; information processor which forms an image of the specimen based on an output signal from the detector; image display means which displays the image formed by the information processor; and electron optics controller which adjusts the electron optics,
the method comprising:
calculating, by the information processor, the amount of adjustment of the deflector based on Fourier transform images corresponding to a plurality of scanning transmission images including a scanning transmission image of the specimen which is obtained after the position of the electron beam is shifted, and a scanning transmission image obtained without shifting the position of the electron beam; and
transferring, by the information processor, the calculated amount of adjustment to the electron optics controller.
